(19) United States
(12) Patent Application Publication
(10) Pub. No.: US 2024/0159963 A1
(43) Pub. Date: May 16, 2024

(54) OPTICAL POWER SPLITTERS

(71) Applicant: Cisco Technology, Inc., San Jose, CA (US)

(72) Inventors: Tao LING, Breinigsville, PA (US); Shiyi CHEN, Breinigsville, PA (US); Jean-Luc J. TAMBASCO, Macungie, PA (US); Ravi S. TUMMIDI, Breinigsville, PA (US)

(21) Appl. No.: 18/054,877

(22) Filed: Nov. 11, 2022

(51) Int. Cl. G02B 6/122

(52) U.S. Cl. CPC G02B 6/1228

(57) ABSTRACT

Embodiments herein describe optical splitters that receive an optical signal using a single mode waveguide where the signal is in a fundamental mode. An asymmetric taper can be used to convert a portion of the optical signal from the fundamental mode into a different order mode (e.g., the first-order mode). The optical splitter also includes an optical mode multiplexer with two branches. The portion of the optical signal having the first-order mode is transferred to a first branch of the optical mode mux while the remaining portion of the optical signal having the fundamental mode is transmitted using a second branch of the optical mode mux. Further, coupling the portion of the optical signal into the first branch converts the optical signal from the first-order mode back to the fundamental mode. Thus, both branches in the optical mode mux output optical signals in the fundamental mode.

### TECHNICAL FIELD

Embodiments presented in this disclosure generally relate to optical splitters. More specifically, embodiments disclosed herein describe optical splitters formed using asymmetric tapers and optical mode multiplexers.

### BACKGROUND

Optical splitters that split the power in a received optical signal into two output signals with output powers that are similar (e.g., splitting ratios of 50/50, 55/65, 60/40, etc.) are common and have low loss over a wide range of optical wavelengths (e.g., are broadband). However many applications require the use of optical taps where only a small percentage of the optical signal (e.g., less than 15 percent) is split from the main signal. These applications may use optical splitting ratios of 90/15, 90/10, 95/5, 98/2, etc. Optical splitters with large splitting ratios are typically lossy and only function efficiently for a narrow range of wavelengths (e.g., are not broadband).

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an optical splitter, according to one embodiment, according to one embodiment.

FIG. 2 illustrates an optical splitter with an optical mode multiplexer, according to one embodiment.

FIG. 3 illustrates an optical mode multiplexer, according to one embodiment.

FIG. 4 illustrates a portion of the optical mode multiplexers in FIGS. 2 and 3, according to one embodiment.

FIG. 5 illustrates an asymmetric taper, according to one or more embodiments.

FIGS. 6A-6C illustrate performance data associated with the asymmetric taper shown in FIG. 5, according to one embodiment.

FIG. 7 illustrates an asymmetric taper, according to one or more embodiments.

FIGS. 8A-8C illustrate performance data associated with the asymmetric taper shown in FIG. 7, according to one embodiment.

FIG. 9 illustrates an asymmetric taper, according to one or more embodiments.

FIGS. 10A-10C illustrate performance data associated with the asymmetric taper shown in FIG. 9, according to one embodiment.

FIG. 11 is a flowchart for operating an optical splitter, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is an optical splitter that includes an asymmetrically tapered waveguide comprising a first end configured to receive an optical signal including a single mode and an optical mode mux coupled to a second end of the asymmetrically tapered waveguide. The asymmetrically tapered waveguide is configured to convert a first portion of an optical signal from a fundamental mode to a different order mode while a second portion of the optical signal remains in the fundamental mode. The first portion of the optical signal is transmitted in a first branch of the optical mode mux and is converted back into the fundamental mode before being output by the optical mode mux, and the second portion of the optical signal is transmitted in a second branch of the optical mode mux.

Another embodiment described herein is a photonic chip that includes a single mode waveguide, an asymmetrically tapered waveguide comprising a first end configured to receive an optical signal from the single mode waveguide, and an optical mode mux coupled to a second end of the asymmetrically tapered waveguide. The asymmetrically tapered waveguide is configured to convert a first portion of the optical signal from a fundamental mode to a different order mode while a second portion of the optical signal remains in the fundamental mode. The first portion of the optical signal is transmitted in a first branch of the optical mode mux and is converted back into the fundamental mode, and the second portion of the optical signal is transmitted in a second branch of the optical mode mux.

Another embodiment described herein is a method that includes receiving an optical signal having a single mode, converting a portion of the optical signal from a fundamental mode to a different order mode, transferring the portion of the optical signal in the different order mode into a first branch of an optical mode mux and converting the portion of the optical signal back into the fundamental mode, and transmitting a remaining portion of the optical signal in a second branch of the optical mode mux.

### Example Embodiments

Embodiments herein describe optical splitters that can provide large power splitting ratios where a small percentage of the power is being tapped (e.g., less than 15 percent). Moreover, these optical splitters are low-loss and function for a wide range of optical wavelengths (e.g., are broadband). In one embodiment, the optical splitters receive an optical signal using a single mode waveguide where the signal is in a fundamental mode. An asymmetric taper is used to convert a portion of the optical signal from the fundamental mode into a different order mode (e.g., the first-order mode).

The optical splitter also includes an optical mode multiplexer (mux) with two branches. Due to the geometry of the optical mode mux, the portion of the optical signal having the first-order mode is transferred to a first branch of the optical mode mux while the remaining portion of the optical signal having the fundamental mode is transmitted using a second branch of the optical mode mux. Further, coupling the portion of the optical signal into the first branch converts the optical signal from the first-order mode back to the fundamental mode. Thus, both branches in the optical mode mux output optical signals in the fundamental mode.

The geometry of the asymmetric taper controls how much of the optical signal is converted into the first-order mode, and thus, how much of the optical signal is transferred to the first branch in the optical mode mux, thereby setting the power splitting ratio of the optical splitter. In this manner, the optical splitter can provide large power splitting ratios (e.g., where less than 15 percent of the optical power is split out) and is low-loss for a wide range of optical wavelengths.

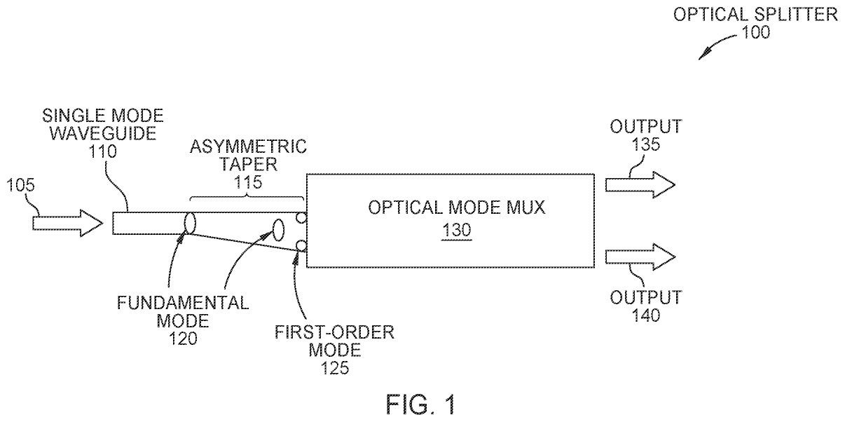

FIG. 1 illustrates an optical splitter 100, according to one embodiment. The optical splitter 100 includes a single mode waveguide 110 which receives an input optical signal 105 that is in the fundamental mode. That is, the single mode waveguide 110 efficiently transmits only optical signals that are in the fundamental mode.

The single mode waveguide 110 is connected to an input of an asymmetric taper 115 (e.g., an asymmetrically tapered waveguide). As shown, the optical signal 105 has the fundamental mode 120 when entering the asymmetric taper 115, but due to the asymmetry of the taper 115, the optical signal 105 at the output of the asymmetric taper 115 includes both the fundamental mode 120 and the first-order mode 125. While an asymmetric taper 115 is described as the structure for converting a portion of the optical signal 105 into a different order mode, any suitable structure that can perform this conversion can be used. Thus, the embodiments herein are not limited to an asymmetric taper 115 as the means for converting a portion of the optical signal 105 to a higher-order mode.

The taper 115 is asymmetric such that a center axis of the input of the taper 115 is misaligned with a center axis of an output of the taper 115. The amount of offset or misalignment between the center axes of the input and output of the asymmetric taper 115 determines the amount of power in the optical signal 105 that is converted from the fundament mode 120 into the first-order mode 125. This also determines the power splitting ratio of the optical splitter 100. Different implementations of the asymmetric taper 115 are described in more detail in FIGS. 6-10 below.

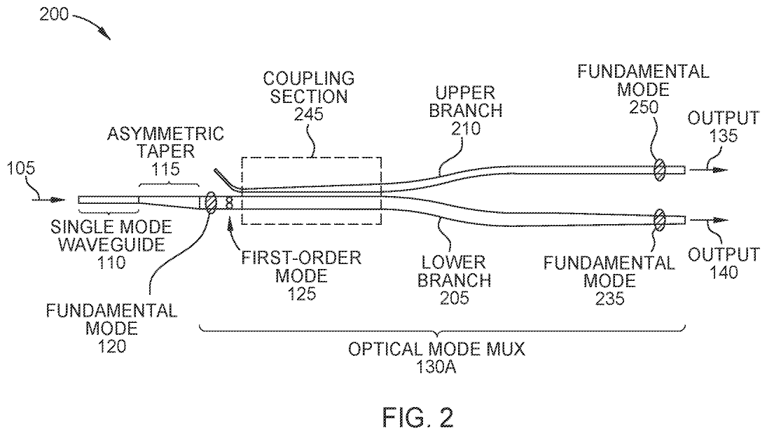

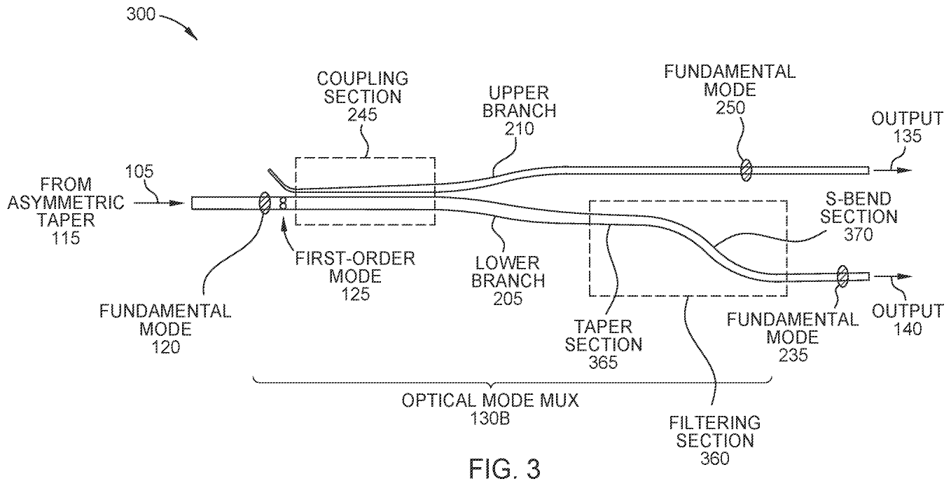

The output of the asymmetric taper 115 is coupled to an optical mode mux 130. Different implementations of the optical mode mux 130 are described in FIGS. 2 and 3 below. In general, the optical mode mux 130 splits the portion of the optical signal 105 having the first-order mode 125 from the portion of the optical signal 105 having the fundamental mode 120. Further, the optical mode mux 130 converts the portion of the optical signal 105 having the first-order mode 125 back into the fundamental mode. The output 135 of the mux 130 corresponds to the portion of the optical signal 105 that was converted into the first-order mode and then converted back into the fundamental mode, while the output 140 of the mux 130 corresponds to the portion of the optical signal 105 that remained in the fundamental mode. Thus, the outputs 135 and 140 are two separate optical signals that both have the fundamental mode.

In one embodiment, the output 135 may have a much lower power than the output 140. For example, the optical splitter 100 may split the power in the input optical signal 105 such that the output 135 has 15 percent or less of its optical power while the output 140 has the remaining optical power. In one embodiment, the optical splitter 100 has a power ratio that ranges from 85/15 to 99/1. However, in other embodiments, the optical splitter 100 may have a power ratio that is smaller than 85/15, such as 80/20 or 75/25. This power ratio can be set by the geometry of the asymmetric taper 115 as described below.

In one embodiment, the single mode waveguide 110, the asymmetric taper 115, and the optical mode mux 130 can be formed from one or more semiconductor materials (e.g., silicon or other suitable semiconductor material). In one embodiment, the optical splitter 100 may be implemented on a photonic chip or photonic integrated circuit.

FIG. 2 illustrates an optical splitter 200 with an optical mode mux 130A, according to one embodiment. The optical splitter 200 includes the single mode waveguide 110 and the asymmetric taper 115 which receive the input optical signal 105 having the fundamental mode 120 and convert a portion of the optical signal 105 into the first order mode 125, as discussed above. The optical signal 105 is then transmitted to the optical mode mux 130A.

The mux 130A comprises a lower branch 205 (e.g., a first optical waveguide) arranged proximately to an upper branch 210 (e.g., a second optical waveguide). IN this example, the upper branch 210 is spaced apart from the lower branch 205 such that there is a gap between the two branches and they are not directly connected or physically coupled to each other. The lower branch 205 and the upper branch 210 may be formed of any semiconductor material(s) suitable for propagating light, such as monocrystalline silicon, silicon nitride, polysilicon, and so forth. In some embodiments, the lower branch 205 and the upper branch 210 are formed in a layer of a silicon-on-insulator (SOI)-based device. For example, the lower branch 205 and the upper branch 210 may be formed in an active (silicon) layer of an SOI wafer, a silicon nitride layer deposited above the active layer, and so forth.

The lower branch 205 extends from an output of the asymmetric taper 115 to the output 140. The optical signal 105 received at the lower branch 205 includes one or more modes, such as one or more transverse electric (TE) modes and/or one or more transverse magnetic (TM) modes. The one or more modes of the optical signal may include a fundamental mode (TE0, TM0), a first order mode (TE1, TM1), a second order mode, or higher-order modes. The order of the mode may refer to and/or be indicative of a spatial symmetry of the light energy in the optical signal 105 relative to a central axis of propagation. A fundamental mode of the optical signal 105 typically includes a single concentration of light energy that is centrally located on the axis of propagation.

As shown, a fundamental mode 235 (e.g., TE0) of the optical signal 105 propagates to the output 140, although other order modes are also contemplated.

The lower branch 205 and the upper branch 210 are dimensioned and arranged such that the upper branch 210 evanescently couples with a coupling section 245 of the lower branch 205. In some embodiments, a second input mode of the optical signal 105 entering the optical mode mux 130A is evanescently coupled into the upper branch 210, such that light from the optical signal 105 propagates through the upper branch 210 to the output 135. In this embodiment, a first order mode 125 (e.g., TE1) of the optical signal 105 evanescently couples to the upper branch 210, although other order modes are also contemplated.

In some embodiments, evanescently coupling the second input mode into the upper branch 210 operates to convert the mode of the optical signal 105 within the upper branch 210, such that the output 135 includes the converted mode. As shown, evanescently coupling the first order mode 125 into the upper branch 210 converts the first order mode 125 back into a fundamental mode 250, although other order modes are also contemplated.

FIG. 3 illustrates an optical mode mux 130B for an optical splitter, according to one embodiment. Like in FIG. 2, the optical mode mux 130B receives the optical signal 105 which has passed through the asymmetric taper 115 (which is not shown in FIG. 3). Thus, the optical signal 105 includes both the first order mode and a second order mode (e.g., a fundamental mode and a first-order mode). The optical mode mux 130B includes many of the same optical components as the optical mode mux 130A as indicated by using the same reference number. These optical components operate in the same manner as discussed above, and thus are not discussed in detail here.

Unlike the mux 130A in FIG. 2, the mux 130B further defines a filtering section 360 between the coupling section 245 and the output 140. The filtering section 360 is configured to filter one or more input modes of the optical signal 105, e.g., other than the fundamental mode 120. In some embodiments, the filtering section 360 comprises a taper section 365 that tapers away from the coupling section 245 toward the output 140. For example, for the direction of propagation of the optical signal 105 shown in FIG. 3, the taper section 365 has a wider width at an entry of the optical signal 105 and a narrower width at an exit of the optical signal 105. The tapering of the taper section 365 may be effective to filter (or mitigate) input modes other than the fundamental mode 120. Other tapering is also contemplated, such as tapering a height of the lower branch 205 along the direction of propagation of the optical signal 105. Further, the taper section 365 may be contoured to filter one or more specific input modes. The dimensions of the taper section 365 may have any suitable dimensioning according to the design of the mux 1308.

In some embodiments, the filtering section 360 further comprises an S-bend section 370 between the taper section 365 and the output 140. The dimensions of the filtering section 360 may have any suitable dimensioning according to the design of the mux 130B. In some cases, each of the taper section 365 and the S-bend section 370 may operate to selectively propagate one input mode (e.g., the fundamental mode 120) while selectively mitigating other input mode(s) such as the first order mode 125. In some embodiments, the output 140 includes the selectively propagated mode.

Described another way, some implementations of the filtering section 360 include only a taper section 365, some implementations of the filtering section 360 include only an S-bend section 370, and some implementations of the filtering section 360 include both a taper section 365 and a S-bend section 370. Further, in an alternate implementation, the S-bend section 370 may be arranged before the taper section 365 within the filtering section 360.

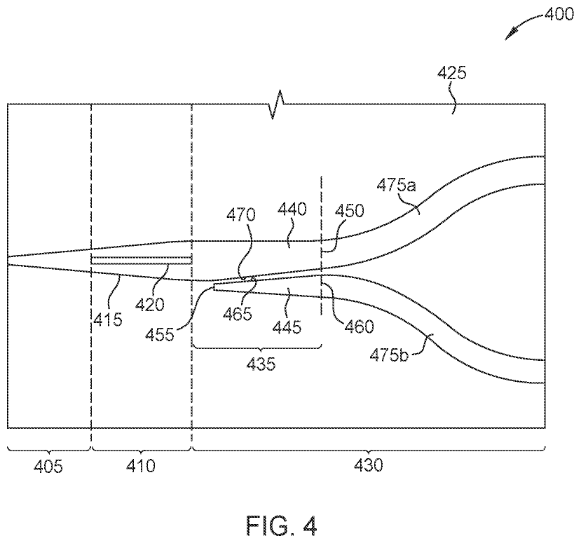

FIG. 4 illustrates a portion of the optical mode muxes in FIGS. 2 and 3, according to one embodiment. The features illustrated in FIG. 4 may be used in conjunction with other embodiments. For example, the optical waveguide structure 400 may represent an example implementation of the coupling section 245 of FIGS. 2 and 3.

The optical waveguide structure 400 comprises a nanotaper 405 (which may also be referred to as an inverse taper) that couples a pair of orthogonally-polarized optical signals that are received from an external source to the optical waveguide structure 400. In some embodiments, the external source and the optical waveguide structure 400 are co-planar and the orthogonally-polarized optical signals are received through direct or end-fire coupling. The nanotaper 405 concentrates the orthogonally-polarized optical signals as a fundamental mode (TE0) optical signal and a fundamental mode (TM0) optical signal.

The optical waveguide structure 400 further comprises a rotator 410 that is configured to convert or rotate the fundamental mode TM0 optical signal into a first order mode (TE1) optical signal, and to maintain the fundamental mode TE0 optical signal. The rotator 410 may perform the conversion and maintenance of the TE0 and TM0 optical signals, respectively, as the TE0 and TM0 optical signals propagate through the rotator 410.

The rotator 410 comprises a base portion 415 and a rib portion 420. The base portion 415 may be a generally planar structure that that may be co-planar with the nanotaper 405. In addition, the base portion 415 may inversely taper or have a width that increases from a first width substantially equal to the width of the nanotaper 405 (e.g., 300-400 nm) to a second width (e.g., 1 um), although other values of the first width and second width are contemplated.

In some embodiments, the rib portion 420 is a relatively thin strip of material that is disposed on, or that extends or protrudes from, a planar surface of the base portion 415 that is opposite an opposing planar surface of the base portion 415 in contact with the substrate 425.

As shown in FIG. 4, the rib portion 420 may extend an entire length of the rotator 410 substantially in the direction of propagation. In alternate implementations, the rib portion 420 may not extend the entire length of the rotator 410. In still other example configurations, the rib portion 420 may extend over the nanotaper 405 so that at least a portion of the nanotaper 405 includes a rib portion extending from a planar surface of the nanotaper 405.

The rib portion 420 may have a width that is less or substantially less than any of the widths of the base portion 415. In some implementations, the width of the rib portion 420 may be substantially uniform as the rib portion 420 extends. For example, the uniform width of the rib portion 420 may be about 150 nm, although other widths are also contemplated. In alternate implementations, the rib portion 420 has a width that varies as the rib portion 420 extends. For example, the width of the rib portion 420 may taper similar to, or in the same direction, as the tapering of the base portion 415. In another example, the width of the rib portion 420 may taper in the opposite direction as the tapering of the base portion 415.

The optical waveguide structure 400 further comprises a separator 430 that is configured to separate the TE0 optical signal and the TE1 optical signal into separate optical waveguides or waveguide paths. The separator 430 comprises an asymmetric Y-splitter 435 that is asymmetric relative to the direction of propagation. In some embodiments, the asymmetric Y-splitter 435 comprises a dual waveguide structure in which a first optical waveguide receives the TE0 and TE1 optical signals, and a second optical waveguide couples away the TE1 optical signal from the first optical waveguide and converts TE1 mode into TE0 mode, so that the original TE0 and TE1 optical signals are directed onto separate optical waveguide paths.

As shown in FIG. 4, the asymmetric Y-splitter 435 may include a first taper section 440 and a second taper section 445. The first taper section 440 may abut or connect to the output of the rotator 410. The first taper section 440 may taper down from a first width at the output of the rotator 410 to a second width at a second end 450. The second taper section 445 may inversely taper or increase in width from a first end 455 having a small width or converging at a point, to a second end 460 having a width that may be different than the width of the first taper section 440 at the second end 450.

In some embodiments, the widths of the first taper section 440 and the second taper section 445 are selected so that the second taper section 445 couples either the TE0 optical signal or the TE1 optical signal away from the first taper section 440, while the other of the TE0 optical signal or the TE1 optical signal remains coupled to the first taper section 440. In this way, the TE0 optical signal and the TE1 optical signal are in separate optical waveguide paths at the second ends 450, 460 to achieve modal diversity. Thus, in some embodiments, a first optical waveguide comprises a first taper section 440 that is arranged adjacent to a complementary second taper section 445 of a second optical waveguide.

In cases where the width of the first taper section 440 at the second end 450 is larger than the width of the second taper section 445 at the second end 460, as shown in FIG. 4, the TE0 optical signal may remain coupled to the first taper section 440 and the TE1 optical signal may be coupled to the second taper section 445. In an alternate implementation, the width of the first taper section 440 at the second end 450 may be smaller than the width of the second taper section 445 at the second end 460, such that the TE1 optical signal remains coupled to the first taper section 440 and the TE0 optical signal is coupled to the second taper section 445.

Although described in terms of coupling substantially all of the energy of the TE0 optical signal into a selected one of the first taper section 440 and the second taper section 445, and substantially all of the energy of the TE1 optical signal into the other of the first taper section 440 and the second taper section 445, alternate implementations may direct different proportions of the energies of the TE0 optical signal and the TE1 optical signal into the first taper section 440 and the second taper section 445. Further, in alternate implementations, the optical waveguide structure 400 may include the asymmetric Y-splitter 435 while omitting the rotator 410.

As shown in FIG. 4, the second taper section 445 includes a side 465 that faces and extends substantially parallel to a side 470 of the first taper section 440. The sides 465, 470 are spaced apart from each other by an appropriate distance or spacing so that coupling away of the TE1 optical signal to the second taper section 445 may be achieved. Additionally, coupling portions 475a, 475b, which may include S-bends, other curved structures, and/or straight structures, may be coupled to the second ends 450, 460 to widen the separate optical waveguide paths for transmitting the TE0 optical signal and the TE1 optical signal, which finally has been converted into TE0 mode.

In some embodiments, one or more components of the optical waveguide structure 400 are implemented as adiabatic structures. That is, the one or more components may have lengths selected such that the different functions (such as splitting and coupling of the optical signals) are performed with minimal energy loss and high isolation as the optical signals propagate through the optical waveguide structure 400. The lengths may be significantly greater than the wavelengths of the optical signals, and in some cases may be relatively greater for closer index values of the different modes. In some embodiments, the lengths of the adiabatic structures may be at least ten times greater than the wavelengths of the optical signals.

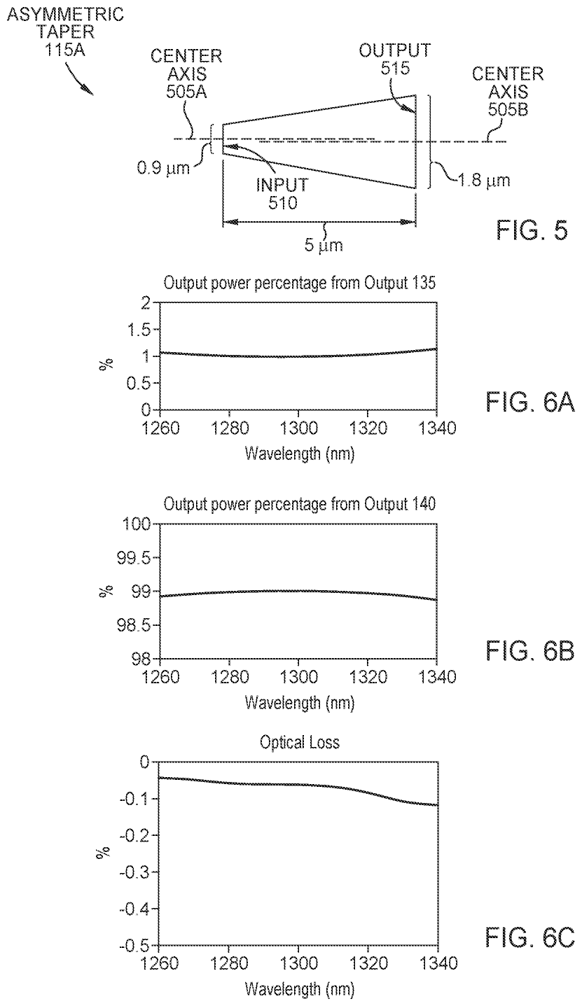

FIG. 5 illustrates an asymmetric taper 115A, according to one or more embodiments. That is, FIG. 5 illustrates one example of the waveguide asymmetric taper 115 shown in FIG. 1. The asymmetric taper 115A includes an input 510 on the side of the taper 115A that couples to the single mode waveguide 110 and an output 515 on the side of the taper 115A that couples to the optical mode mux 130 in FIG. 1.

In this example, the width of the taper 115A increases in the direction of propagation of the optical signal from the input 510 to the output 515. As such, the width of the input 510 is smaller than the width of the output 515. In this example, the width of the side of the input 510 is 0.9 microns while the width of the side of the output 515 is 1.8 microns. However, these are just example widths of the input 510 and the output 515 and in other implementations the widths can vary. Also, the length (i.e., the distance from the input 510 and the output 515) can be approximately five microns but this can also vary depending on the implementation.

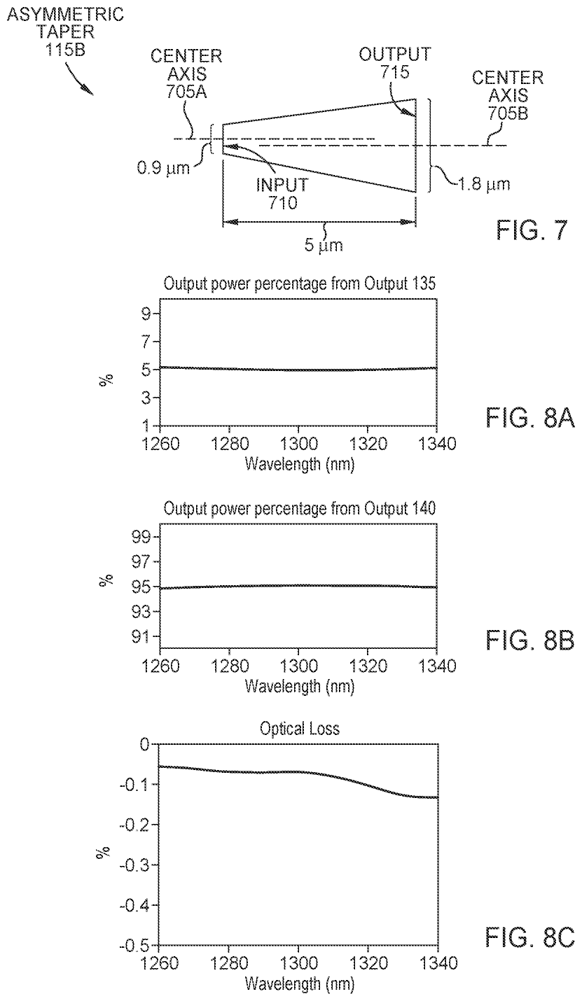

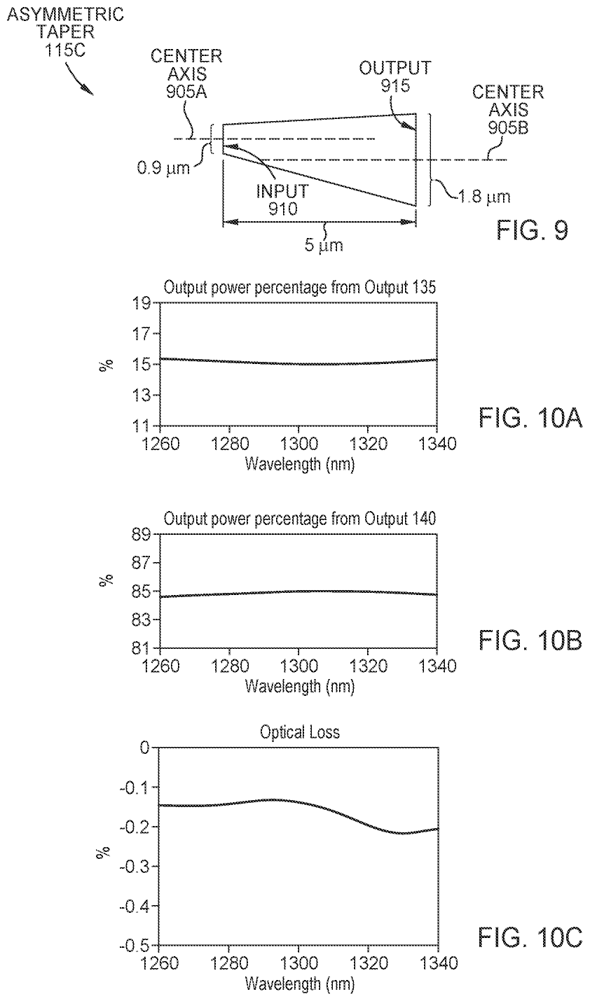

Further, the centers of the input 510 and the output 515 are offset 0.1 microns. That is, a center axis 505A for the input 510 is misaligned with the center axis 505B for the output 515, thus providing the asymmetric taper (where in a symmetric taper waveguide the center axes for the input and output would be aligned—i.e., the same). As will be discussed in FIGS. 7 and 9, the misalignment between the center axes 505 can be adjusted or set to control the amount of power in the optical signal that is converted from the fundamental optical mode to a different optical mode (e.g., a first-order mode).

FIGS. 6A-6C illustrate performance data associated with the asymmetric taper shown in FIG. 5, according to one embodiment. FIG. 6A illustrates the output power percentage from the output 135 in FIG. 1 when using the asymmetric taper 115A in FIG. 5. As shown, the percentage of power being transmitted via the output 135 remains essentially the same (˜1% of the input optical signal 105) regardless of the wavelength of the input optical signal 105. As such, FIG. 6A illustrates the asymmetric taper 115 has a high bandwidth since it has a consistent performance across the wavelength range of 1260-1340 nm.

FIG. 6B illustrates the output power percentage from the output 140 in FIG. 1, which is approximately 99% across the wavelength range of 1260-1340 nm.

FIG. 6C illustrates the optical loss of the optical splitter 100 when using the asymmetric taper 115A in FIG. 5. As shown, for the wavelength range of 1260-1340 nm, the optical loss is less than 0.12 dB, illustrating that the optical splitter 100 is low loss.

FIG. 7 illustrates an asymmetric taper 115B, according to one or more embodiments. That is, FIG. 7 illustrates one example of the waveguide asymmetric taper 115 shown in FIG. 1. The asymmetric taper 115B includes an input 710 on the side of the taper 115B that couples to the single mode waveguide 110 and an output 715 on the side of the taper 115B that couples to the optical mode mux 130 in FIG. 1.

In this example, the width of the taper 115B increases in the direction of propagation of the optical signal from the input 710 to the output 715. As such, the width of the input 710 is smaller than the width of the output 715. The length and width of the asymmetric taper 115B may be similar to the taper 115A in FIG. 5.

The centers of the input 710 and the output 715 are offset by 0.23 microns. That is, a center axis 705A for the input 710 is misaligned with the center axis 705B for the output 715, thus providing the asymmetric taper. Specifically, the center axes 705 in FIG. 7 are more offset than the center axes 505 in FIG. 5. This increased misalignment between the center axes 705 results in more of power in the optical signal being converted from the fundamental optical mode to a different optical mode than in the taper 115A in FIG. 5.

FIGS. 8A-8C illustrate performance data associated with the asymmetric taper shown in FIG. 7, according to one embodiment. FIG. 8A illustrates the output power percentage from the output 135 in FIG. 1 when using the asymmetric taper 115B in FIG. 7. As shown, the percentage of power being transmitted via the output 135 remains essentially the same (˜5% of the input optical signal 105) regardless of the wavelength of the input optical signal 105. As such, FIG. 8A illustrates the asymmetric taper 115B has a high bandwidth since it has a consistent performance across the wavelength range of 1260-1340 nm.

FIG. 8B illustrates the output power percentage from the output 140 in FIG. 1, which is approximately 95% across the wavelength range of 1260-1340 nm.

FIG. 8C illustrates the optical loss of the optical splitter 100 when using the asymmetric taper 115B in FIG. 7. As shown, for the wavelength range of 1260-1340 nm, the optical loss is less than 0.15 dB, illustrating that the optical splitter 100 is low loss.

FIG. 9 illustrates an asymmetric taper, according to one or more embodiments. That is, FIG. 9 illustrates one example of the waveguide asymmetric taper 115 shown in FIG. 1. The asymmetric taper 115C includes an input 910 on the side of the taper 115C that couples to the single mode waveguide 110 and an output 915 on the side of the taper 115C that couples to the optical mode mux 130 in FIG. 1.

In this example, the width of the taper 115C increases in the direction of propagation of the optical signal from the input 910 to the output 915. As such, the width of the input 910 is smaller than the width of the output 915. The length and width of the asymmetric taper 115C may be similar to the taper 115A in FIG. 5.

A center axis 905A for the input 910 is misaligned by 0.42 microns with the center axis 905B for the output 915, thus providing the asymmetric taper. Specifically, the center axes 905 in FIG. 7 are more offset than the center axes 505 in FIG. 5 and the center axes 705 in FIG. 7. This increased misalignment between the center axes 905 results in more of power in the optical signal being converted from the fundamental optical mode to a different optical mode than in the taper 115A in FIG. 5 and the taper 115B in FIG. 7.

FIGS. 10A-10C illustrate performance data associated with the asymmetric taper shown in FIG. 9, according to one embodiment. FIG. 10A illustrates the output power percentage from the output 135 in FIG. 1 when using the asymmetric taper 115C in FIG. 9. As shown, the percentage of power being transmitted via the output 135 remains essentially the same (˜15% of the input optical signal 105) regardless of the wavelength of the input optical signal 105. As such, FIG. 10A illustrates the asymmetric taper 115C has a high bandwidth since it has a consistent performance across the wavelength range of 1260-1340 nm.

FIG. 10B illustrates the output power percentage from the output 140 in FIG. 1, which is approximately 85% across the wavelength range of 1260-1340 nm.

FIG. 10C illustrates the optical loss of the optical splitter 100 when using the asymmetric taper 115C in FIG. 9. As shown, for the wavelength range of 1260-1340 nm, the optical loss is less than 0.22 dB, illustrating that the optical splitter 100 is low loss.

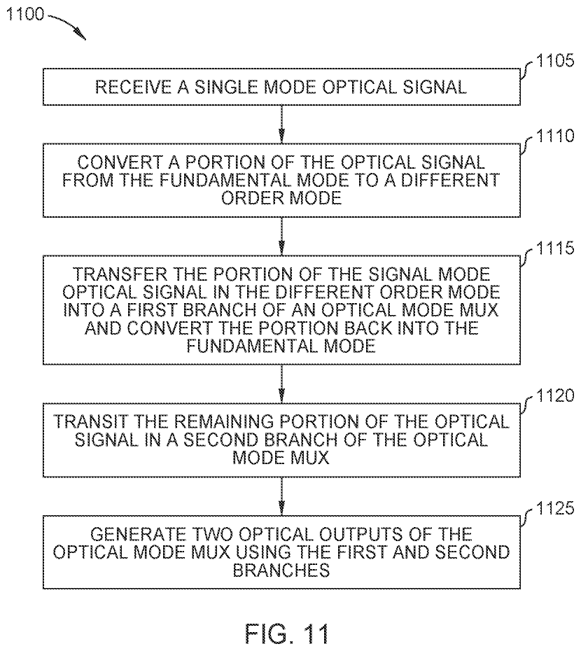

FIG. 11 is a flowchart of a method 1100 for operating an optical splitter, according to one embodiment. At block 1105, the optical splitter (e.g., the optical splitter 100 in FIG. 1) receives a single mode optical signal from a single mode optical waveguide.

At block 1110, the optical splitter uses a portion of a waveguide having an asymmetric taper (e.g., the tapers 115 illustrates in FIGS. 5, 7, and 9) to convert a portion of the single mode optical signal from the fundamental mode to a different order mode.

At block 1115, an optical mode mux in the optical splitter transfers the portion of the single mode optical signal in the different order mode into a first branch and converts the portion back into the fundamental mode.

At block 1120, the remaining portion of the single mode optical signal (assuming no optical loss) is transmitted in a second branch of the optical mode mux.

At block 1125, the optical mode mux generates two optical outputs using the first and second branches. The two optical outputs of the optical mode mux both have the fundamental mode.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

In view of the foregoing, the scope of the present disclosure is determined by the claims that follow.

We claim:

1. An optical splitter, comprising:
an asymmetrically tapered waveguide comprising a first end configured to receive an optical signal comprising a single mode; and
an optical mode mux coupled to a second end of the asymmetrically tapered waveguide,
wherein the asymmetrically tapered waveguide is configured to convert a first portion of an optical signal from a fundamental mode to a different order mode while a second portion of the optical signal remains in the fundamental mode,
wherein the first portion of the optical signal is transmitted in a first branch of the optical mode mux and is converted back into the fundamental mode before being output by the optical mode mux, and the second portion of the optical signal is transmitted in a second branch of the optical mode mux.

2. The optical splitter of claim 1, wherein a center axis of the first end of the asymmetrically tapered waveguide is misaligned with a center axis of the second end of the asymmetrically tapered waveguide.

3. The optical splitter of claim 2, wherein the misalignment between the center axes of the first and second ends affects an amount of power of the optical signal that is converted into the different order mode and transmitted on the first branch of the optical mode mux.

4. The optical splitter of claim 2, wherein the misalignment between the center axes of the first and second ends sets a power splitting ratio between outputs of the first and second branches in the optical mode mux.

5. The optical splitter of claim 1, wherein the second branch of the optical mode mux is physically coupled to the second end of the asymmetrically tapered waveguide, wherein the first branch is spaced apart from the second branch by a gap.

6. The optical splitter of claim 5, wherein the first branch is not directly connected to either the second branch or the asymmetrically tapered waveguide.

7. The optical splitter of claim 1, wherein the different order mode is a first order mode.

8. A photonic chip, comprising:
a single mode waveguide;
an asymmetrically tapered waveguide comprising a first end configured to receive an optical signal from the single mode waveguide; and
an optical mode mux coupled to a second end of the asymmetrically tapered waveguide,
wherein the asymmetrically tapered waveguide is configured to convert a first portion of the optical signal from a fundamental mode to a different order mode while a second portion of the optical signal remains in the fundamental mode,
wherein the first portion of the optical signal is transmitted in a first branch of the optical mode mux and is converted back into the fundamental mode, and the second portion of the optical signal is transmitted in a second branch of the optical mode mux.

9. The photonic chip of claim 8, wherein a center axis of the first end of the asymmetrically tapered waveguide is misaligned with a center axis of the second end of the asymmetrically tapered waveguide.

10. The photonic chip of claim 9, wherein the misalignment between the center axes of the first and second ends affects an amount of power of the optical signal that is converted into the different order mode and transmitted on the first branch of the optical mode mux.

11. The photonic chip of claim 9, wherein the misalignment between the center axes of the first and second ends sets a power splitting ratio between outputs of the first and second branches in the optical mode mux.

12. The photonic chip of claim 8, wherein the second branch of the optical mode mux is physically coupled to the second end of the asymmetrically tapered waveguide, wherein the first branch is spaced apart from the second branch by a gap.

13. The photonic chip of claim 12, wherein the first branch is not directly connected to either the second branch or the asymmetrically tapered waveguide.

14. The photonic chip of claim 8, wherein the different order mode is a first order mode.

15. A method, comprising:
receiving an optical signal having a single mode;
converting a portion of the optical signal from a fundamental mode to a different order mode;
transferring the portion of the optical signal in the different order mode into a first branch of an optical mode mux and converting the portion of the optical signal back into the fundamental mode; and
transmitting a remaining portion of the optical signal in a second branch of the optical mode mux.

16. The method of claim 15, wherein converting a portion of the optical signal from a fundamental mode to a different order mode is performed using an asymmetric taper.

17. The method of claim 16, wherein a center axis of a first end of the asymmetric taper is misaligned with a center axis of a second end of the asymmetric taper.

18. The method of claim 17, wherein the misalignment between the center axes of the first and second ends affects an amount of power of the optical signal that is converted into the different order mode and transmitted on the first branch of the optical mode mux.

19. The method of claim 15, wherein a power ratio between an output of the first branch and an output of the second branch is less than 15/85.

20. The method of claim 19, wherein the power ratio between the output of the first branch and the output of the second branch is less than 10/90.
